(19) United States
(12) Patent Application Publication
(10) Pub. No.: US 2012/0026385 A1
(43) Pub. Date: Feb. 2, 2012

(54) ELECTRONIC DEVICE WITH POWER SAVING FUNCTION AND OPERATING METHOD THEREOF

(75) Inventors: PING-YANG CHUANG, Tu-Cheng (TW); YING-CHUAN YU, Tu-Cheng (TW)

(73) Assignee: HON HAI PRECISION INDUSTRY CO., LTD., Tu-Cheng (TW)

(21) Appl. No.: 12/953,480

(22) Filed: Nov. 24, 2010

(30) Foreign Application Priority Data
Jul. 29, 2010 (TW) 99125202

(51) Int. Cl. G03B 13/00; H04N 5/232

(52) U.S. Cl. 348/345; 348/E05.045

(57) ABSTRACT

An electronic device with power saving function is provided. When the power saving function of the electronic device is active, the electronic device obtains the distance between any object in a proximal area of the electronic device and the electronic device and stores the obtained distance as an original distance, and then periodically obtains the distance between the object and the electronic device, and stores the obtained distance as a current distance. The electronic device is put into power saving mode if an difference between the original distance and the current distance does not fall into the predetermined range.

### BACKGROUND

1. Technical Field

The present disclosure relates to an electronic device with power saving function and an operating method thereof.

2. Description of Related Art

Power saving solutions for portable electronic devices often adopt standby or sleep states. However, when a portable electronic apparatus is operated for a period of time with no input received, such as during audio or video playback, such power-saving modes may be implemented in spite of the current operation, and the audio or video playback is interrupt.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a schematic diagram of an electronic device with power saving function in accordance with an exemplary embodiment.

FIG. 2 is a structural diagram of an image obtaining unit of the electronic device 1 of FIG. 1.

FIG. 3 is a block diagram of the electronic device 1 of FIG. 1.

FIG. 4 is a flowchart of power-saving mode implementation method for the electronic apparatus of FIG. 1.

FIG. 5 is a flowchart of power-saving mode recovery method for the electronic apparatus of FIG. 1.

### DETAILED DESCRIPTION

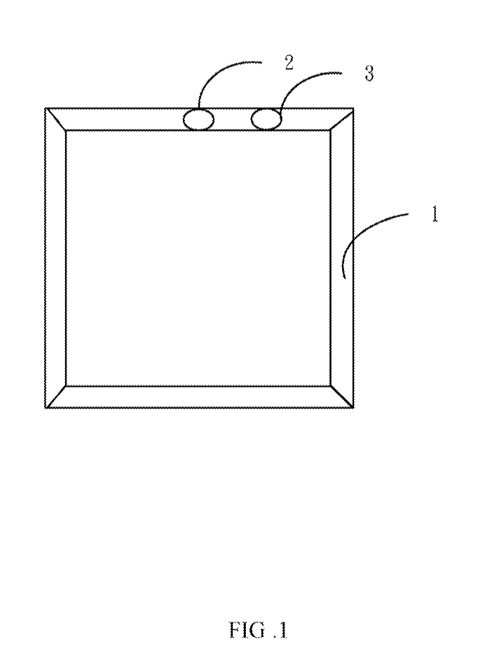

FIG. 1 is a schematic diagram of an electronic device 1 with power saving function (hereinafter “the electronic device”) in accordance with an exemplary embodiment. The electronic device 1 can be, for example, an e-book or a computer. When the power saving function of the electronic device 1 is enabled, and if no user is detected in proximity of the electronic device 1, a power saving mode, such as standby or sleep state, is implemented. When the electronic device 1 is in the power saving mode, no power is provided to selected components. The electronic device 1 includes an image obtaining unit 2 and an illumination unit 3. The image obtaining unit 2 acquires images of the objects in a proximal area of the electronic device 1. The illumination unit 3 provides additional illumination for the image obtaining unit 2 when needed. In this embodiment, the image obtaining unit 2 and the illumination unit 3 are separately mounted outside the electronic device 1. In other embodiments, the illumination unit 3 can integrated into the image obtaining unit 2.

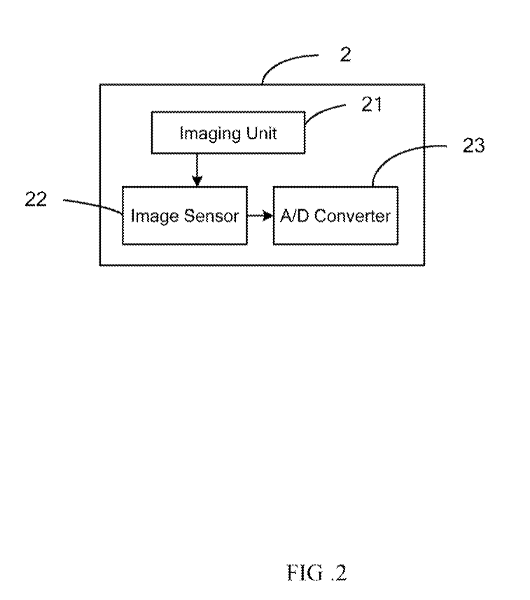

FIG. 2 is a structural diagram of the image obtaining unit 2 of the electronic device 1 of FIG. 1. The image obtaining unit 2 includes an imaging unit 21, an image sensor 22, and an A/D converter 23. The imaging unit 21 is configured for capturing images of a proximal area of the electronic device 1 onto the image sensor 22. The image sensor 22 is configured for converting the image to electric signals. The A/D converter 23 converts the electric signals to digital signals. The image sensor 22 can be CCD or CMOS.

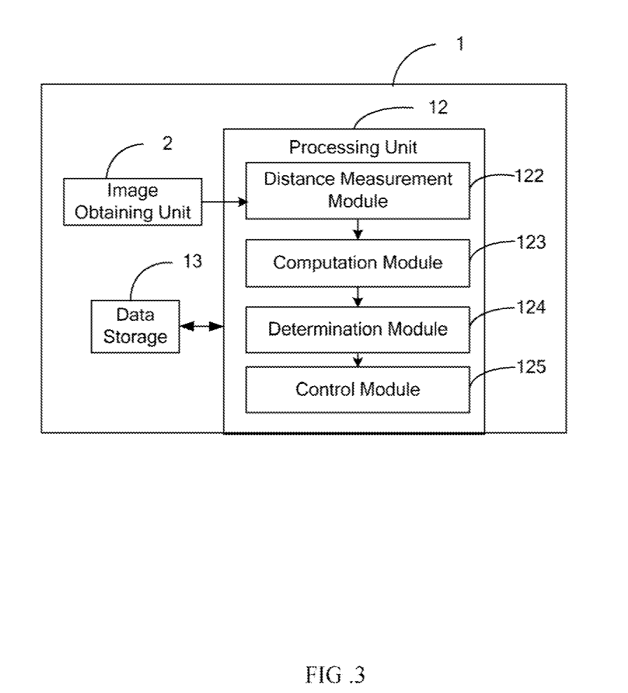

FIG. 3 is a block diagram of the electronic device 1 of FIG. 1. The electronic device 1 further includes a processing unit 12, a data storage 13 and other necessary components (not shown). The processing unit 12 includes a distance measurement module 122, a computation module 123, a determination module 124, and a control module 125.

Once power saving function of the electronic device 1 is enabled, the distance measurement module 122 calculates the distance between the electronic device 1 and any object in a proximal area of the electronic device 1 according to the image obtained by the image obtaining unit 2, and stores the distance as an original distance to the data storage 13. The distance measurement module 123 periodically obtains the distance between the object and the electronic device 1, and stores the distance as a current distance to the data storage 13 after the original distance determined. If there is no object in the proximal area of the electronic device 1, the distance measurement by the distance measurement module is regarded as infinite.

The computation module 123 is configured for computing a difference between the original distance and the current distance. The determination module 124 determines whether the difference between the original distance and the current distance falls within a predetermined range. If the difference between the original distance and the current distance does not fall into the predetermined range, the control module 125 puts the electronic device 1 into power saving mode. If the difference between the original distance and the current distance falls within the predetermined range, the current distance is taken as the original distance and the original distance stored in the data storage 11 is updated accordingly. The predetermined range can be predefined by user input.

When the electronic device 1 is in operation, a standard distance range between the electronic device 1 and the object in a proximal area of the electronic device 1 is generated. For example, the standard distance range for the computer is 0-100 cm, and the standard distance range for e-book is 0-50 cm, if the distance between the object and the electronic device 1 falls within the standard distance range, it is assumed that a user is operating or will operate the electronic device 1, and, conversely, if the distance between the object and the electronic device 1 does not fall into the standard distance range, it can be regarded that no user is present.

In another embodiment, if the difference between the original distance and the current distance falls within the predetermined range, the determination module 124 further determines whether the current distance falls within the standard distance range. If the current distance does not fall into the standard distance, the electronic device 1 is put into power saving mode. If the current distance falls within the standard distance range, the computation module 123 takes the current distance as the original distance and the distance measurement module 122 continues obtaining current distance measurements.

Once the electronic device 1 is in the power-saving mode, the distance measurement module 122 obtains the distance between the object and the electronic device 1 according to the image periodically obtained by the image obtaining unit 2. The predetermined module 124 determines whether the distance falls within the standard distance range. If the distance falls within the standard distance range, the control module 125 recovers the electronic device 1 from the power saving mode.

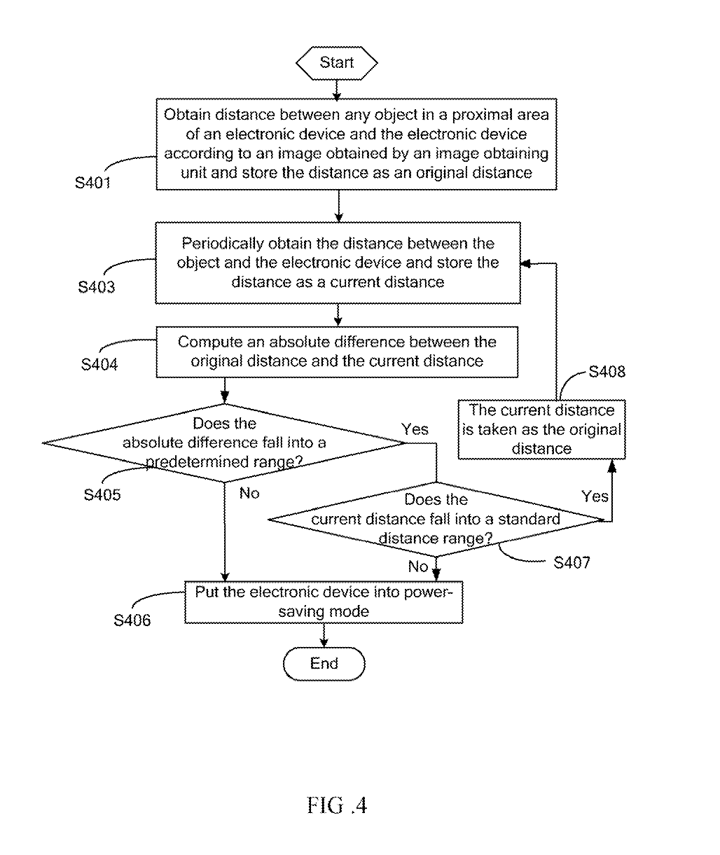

FIG. 4 is a flowchart of power-saving mode implementation method for the electronic apparatus of FIG. 1. In step S401, the distance measurement module 122 obtains the distance between any object in a proximal area of the electronic device 1 and the electronic device 1 according to the image obtained by the image obtaining unit 2, and stores the distance as the original distance to data storage 13.

In step S403, the distance measurement module 123 periodically obtains the distance between the object and the electronic device 1, and stores the distance as a current distance to the data storage 13.

In step S404, the computation module 123 computes the difference between the original distance and the current distance.

In step S405, the determination module 124 determines whether the difference between the original distance and the current distance falls within the predetermined range.

If the difference between the original distance and the current distance does not fall into the predetermined range, in step S406 the control module 125 puts the electronic device 1 into power-saving mode.

If the difference between the original distance and the current distance falls within the predetermined range, in step S 407, the determination module 124 further determines whether the current distance falls within the standard distance range.

If the current distance does not fall into the standard distance, step S406 is implemented.

If the current distance falls into to the standard distance, in step S408, the current distance is taken as the original distance, and step S403 is implemented.

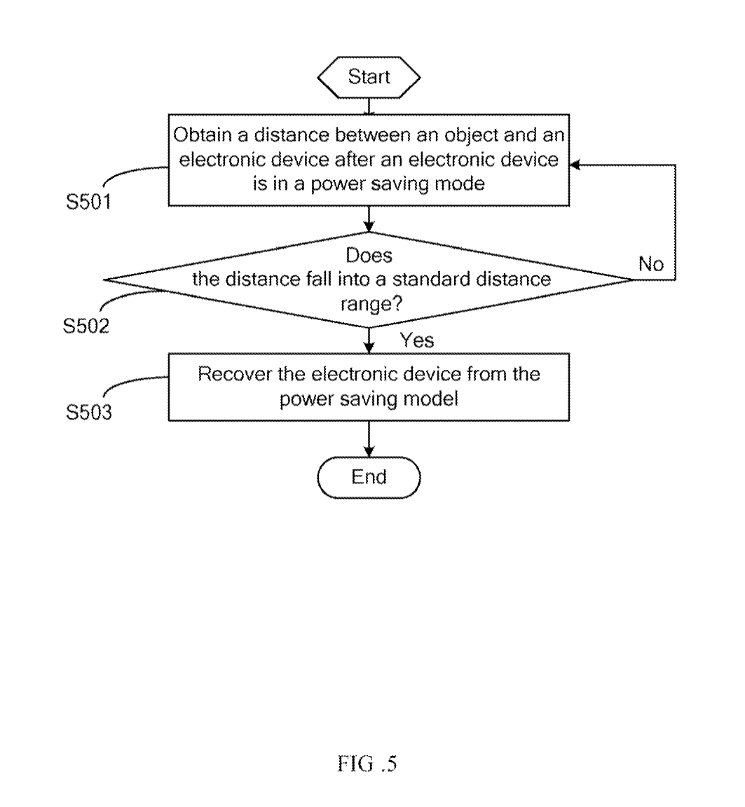

FIG. 5 is a flowchart of power-saving mode recovery method for the electronic apparatus of FIG. 1. In step S501, once electronic device 1 is in power-saving mode, the distance measurement module 122 periodically obtains the distance between the object and the electronic device 1 according to the image obtained by the image obtaining unit 2.

In step S502, the predetermined module 124 determines whether the distance falls within the standard distance range. If the distance does not fall within the standard distance range, step S 501 is implemented.

If the distance falls within the standard distance range, in step S503, the control module 125 recovers the electronic device 1 from the power saving mode.

Although the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. An electronic device with power saving function, comprising:
an image obtaining unit to obtain images of a proximal area of the electronic device;
a distance measurement module to obtain a distance between any object in the proximal area of the electronic device and the electronic device according to the image obtained by the image obtaining unit, and store the obtained distance as an original distance once power saving function of the electronic device is enabled, and periodically obtain a distance between the object in the proximal area of the electronic device and the electronic device according to the image obtained by the image obtaining unit, and store the obtained distance as a current distance after the original distance is determined;
a computation module to compute a difference between the original distance and the current distance;
a determination module for determining whether the difference between the original distance and the current distance falls within a predetermined range, if the difference between the original distance and the current distance falls within the predetermined range, the current distance is taken as the original distance;
a control module for controlling the electronic device to be into the power saving mode if the difference between the original distance and the current distance does not fall into the predetermined range.

2. The electronic device as described in claim 1, wherein if the difference between the original distance and the current distance falls within the predetermined range, the determination module further determines whether the current distance falls within a standard distance range, if the current distance does not fall into the standard distance range, the electronic device is put into power saving mode, if the current distance falls within the standard distance range, the computation module takes the current distance as the original distance.

3. The electronic device as described in claim 1, wherein once electronic device is in a power-saving mode, the distance measurement module periodically obtains the distance between the object in the proximal area and the electronic device according to the image obtained by the image obtaining unit, the predetermined module determines whether the distance falls within the standard distance range, if the distance falls within the standard distance range, the control module recovers the electronic device from the power saving mode.

4. The electronic device as described in claim 1, further comprising an illumination unit, wherein the illumination unit is opened to provide lights to make the image obtaining unit obtain the image of the proximal area of the electronic device when the electronic device in an environment with insufficient light.

5. The electronic device as described in claim 4, wherein the illumination unit is placed to the image obtaining unit.

6. The electronic device as described in claim 1, wherein the image obtaining unit is a camera.

7. The electronic device as described in claim 1, wherein the image obtaining unit comprises an imaging unit, an image sensor, and an A/D converter, the imaging unit is configured for capturing the image of a proximal area of the electronic device to the image sensor, the image sensor is configured for converting the image to electric signal, the A/D converter is configured for converting the electric signal to digital signal and transmits the digital signal to the electronic device.

8. The electronic device as described in claim 1, wherein the image sensor is CCD or CMOS.

9. A method implemented by an electronic device with power saving function, comprising:
obtaining images in a proximal area of the electronic device;
obtaining the distance between any object in a proximal area of the electronic device and the electronic device according to the obtained image, and storing the obtained distance as an original distance once power saving function of the electronic device is active;
periodically obtaining the distance between the object in the proximal area of the electronic device and the electronic device according to the obtained image, and storing the obtained distance as a current distance;
a computation module for computing the difference between the original distance and the current distance;
determining whether the difference between the original distance and the current distance falls within a predetermined range, if the difference between the original distance and the current distance falls within the predetermined range, the current distance is taken as the original distance;
controlling the electronic device to be into the power saving mode if the difference between the original distance and the current distance does not fall into the predetermined range.

10. The method as described in claim 9, further comprising:
determining whether the current distance falls within a standard distance range if the difference between the original distance and the current distance falls within the predetermined range;
controlling the electronic device to be into the power saving mode if the current distance does not fall into the standard distance rang;
taking the current distance as the original distance, if the current distance falls within the standard distance range.

11. The method as described in claim 9, further comprising:
obtaining the distance between the object in a proximal area of the electronic device and the electronic device according to the image obtained by the image obtaining unit once electronic device is in the power saving mode;
determining whether the distance falls within a standard distance range;
recovering the electronic device from the power saving model if the distance falls within the standard distance range.
